(19) United States
(12) Patent Application Publication
(10) Pub. No.: US 2004/0043367 A1
(43) Pub. Date: Mar. 4, 2004

(54) Dancing machine having stepped stages

(76) Inventor: Aileen Chou, Chai Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/231,119

(22) Filed: Aug. 30, 2002

(51) Int. Cl. G09B 9/00; G09B 19/00

(52) U.S. Cl. 434/250; 434/247; 434/307 R

(57) ABSTRACT

A dancing machine includes a base which has stepped stages and each of the two stepped stages has a plurality of step-on pads connected thereon. A signal nit is located in front of the base so as to provide lights, music, and how many calories have been burned. The players move their feet up and down to step on the pads on the stepped stages.

### FIELD OF THE INVENTION

The present invention relates to a dancing machine which includes at least two stepped stages with step-on pads and an information unit to allow the players to step up and down with the tempos of music.

### BACKGROUND OF THE INVENTION

Dancing machines are popular in the past years and provide a stage that is connected with a computerized music playing device. A plurality of step-on pads are connected on the stage and the player has to step on correct pads according the tempos of music. The dancing machine combines music and exercise and is welcomed by youths. However, the stage generally is a flat surface and the pads are also flush with the surface of the stage so that the players could feel boring after a period of time of play. Besides, the flat stage cannot meet requirements of the players who prefer to intense exercise.

The present invention intends to provide a dancing machine that includes at least two stepped stages so that the player may dance up and down to have more fun and exercise.

### SUMMARY OF THE INVENTION

In accordance with one aspect of the present invention, there is provided a dancing machine which comprises a base having two stepped stages and each of the stages has a plurality of step-on pads connected thereon. A signal unit is located in front of the base.

The primary object of the present invention is to provide a dancing machine that has step-on pads on stepped stages so that the players exercises themselves up and down on the stepped stages and this bring more fun to them.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the dancing machine and the signal unit of the present invention;

FIG. 2 is a perspective view to show the dancing machine of the present invention;

FIG. 3 is a perspective view to show the dancing machine of the present invention and a frame is connected to the base of the dancing machine;

FIG. 4 shows that the dancing machine has three stepped stages;

FIG. 5 shows the base is a circular base and a central stage extends from a top surface of the base;

FIG. 6 shows a player is playing the dancing machine, and

FIG. 7 shows each part of the signal unit.

### DETAILED DESCRIPTION OF THE PREFERRED EMBODIMENT

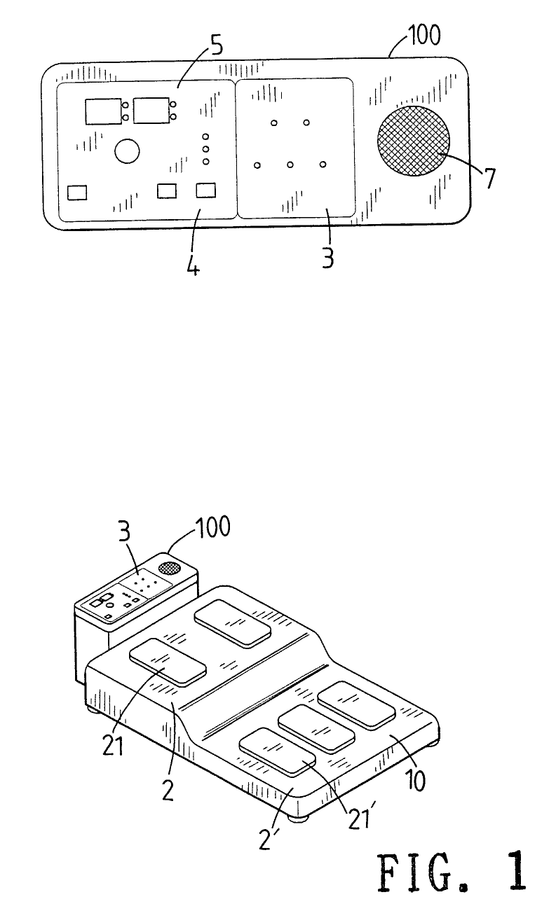

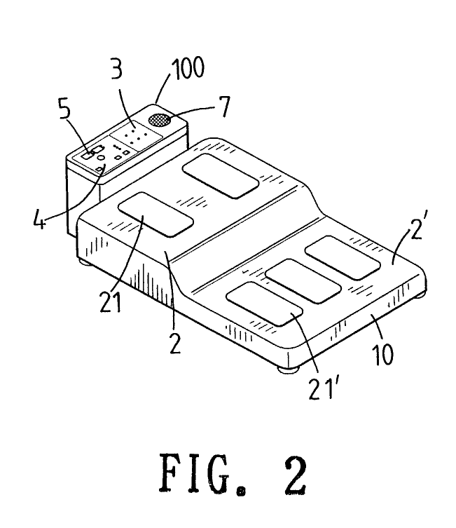

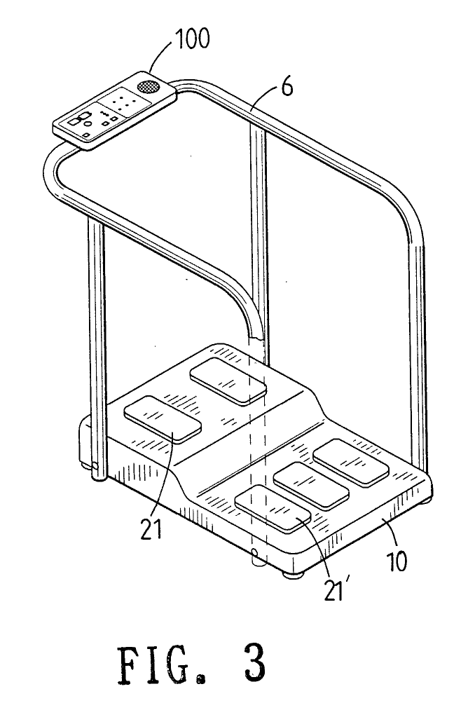

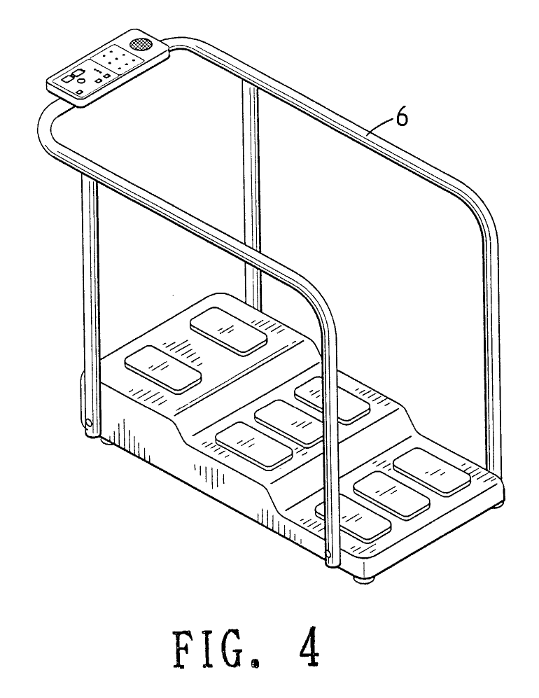

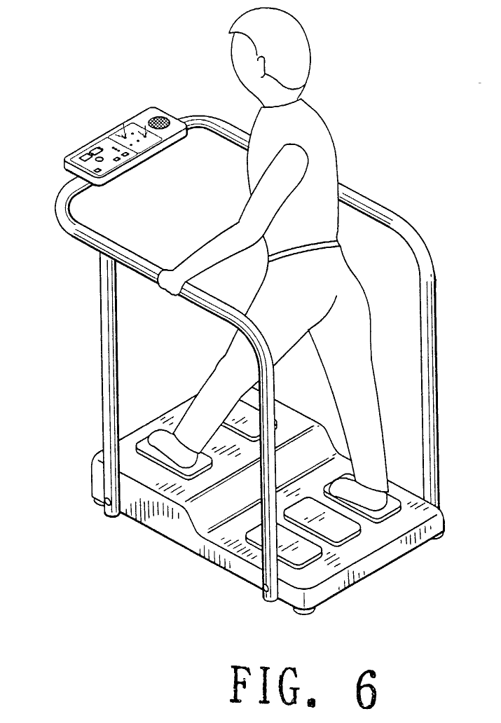

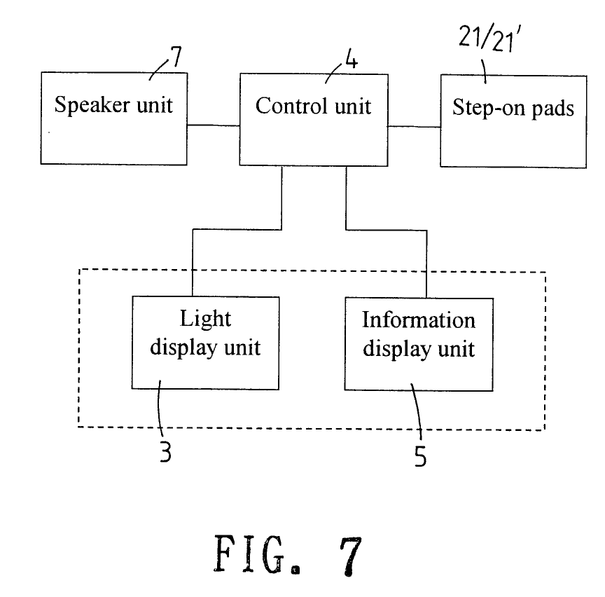

Referring to FIGS. 1 to 3, the dancing machine of the present invention comprises a base 10 that has at least two stepped stages 2, 2′ and each of the at least two stepped stages 2, 2′ has a plurality of step-on pads 21, 21′ connected thereon. The step-on pads 21, 21′ may protrude from a surface of each of the at least two stepped stages 2, 2′ as shown in FIG. 1, or be in flush with a surface of each of the at least two stepped stages 2, 2′ as shown in FIG. 2. Referring to FIG. 7, a signal unit 100 is located in front of the base 10 and includes a light display unit 3, a control unit 4, an information display unit 5, and a speaker unit 7. The step-on pads 21, 21′ are electronically connected to the control unit 4. Further referring to FIG. 6, a frame 6 is connected to the base 10 so that the player may hold the frame 6 while playing, and the signal unit 100 is connected to the frame 6. The number of the stepped stages can be three such as shown in FIG. 4.

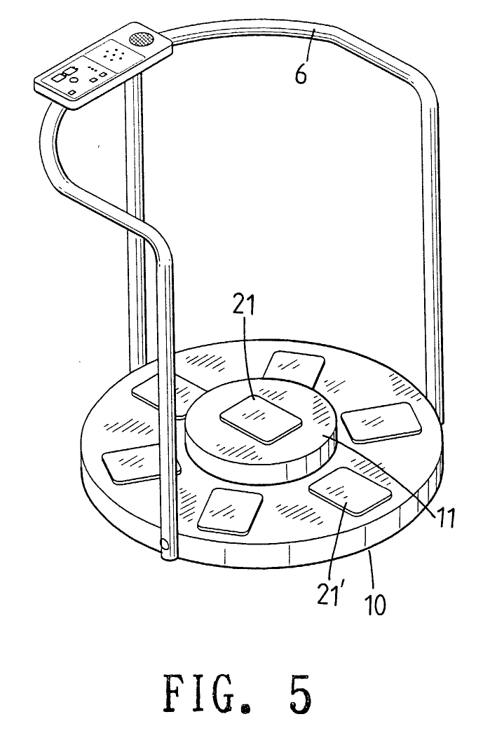

FIG. 5 shows that the base 10 includes a central stage 11 extending from a surface of a circular base 10 and at least one step-on pad 21 is connected on the central stage 11, a plurality of the step-on pads 21′ connected to the surface of the base 10. This special arrangement allows the player to dance on the stages in a circular pattern.

The step-on pads 21, 21′ are able to designed to cooperate with light device which lights up when the pad 21 and/or 21′ is to be stepped on by the player. The dancing machine has multiple stepped stages so that the player can dance up and down and this provides the player more exercise.

While we have shown and described the embodiment in accordance with the present invention, it should be clear to those skilled in the art that further embodiments may be made without departing from the scope of the present invention.

What is claimed is:

1. A dancing machine comprising:
a base having at least two stepped stages and each of the at least two stepped stages having a plurality of step-on pads connected thereon, and
a signal unit located in front of the base.

2. The dancing machine as claimed in claim 1, wherein the step-on pads protrude from a surface of each of the at least two stepped stages.

3. The dancing machine as claimed in claim 1, wherein the step-on pads are in flush with a surface of each of the at least two stepped stages.

4. The dancing machine as claimed in claim 1, wherein the base includes a central stage extending from a surface of base and at least one step-on pad is connected on the central stage, a plurality of the step-on pads connected to the surface of the base.

5. The dancing machine as claimed in claim 1 further comprising a frame connected to the base and the signal unit is connected to the frame.

6. The dancing machine as claimed in claim 1, wherein the signal unit includes a light display unit, an information display unit, and a speaker unit.
